(19) United States
(12) Patent Application Publication
(10) Pub. No.: US 2024/0322617 A1
(43) Pub. Date: Sep. 26, 2024

(54) ELECTRIC MOTOR

(71) Applicant: Mitsubishi Electric Corporation, Tokyo (JP)

(72) Inventors: Kazuchika TSUCHIDA, Tokyo (JP); Ryogo TAKAHASHI, Tokyo (JP); Takaya SHIMOKAWA, Tokyo (JP); Takanori WATANABE, Tokyo (JP)

(21) Appl. No.: 18/262,750

(22) PCT Filed: Mar. 18, 2021
(86) PCT No.: PCT/JP2021/011095

§ 371 Date: Jul. 25, 2023

(51) Int. Cl. H02K 1/14

(52) U.S. Cl. CPC H02K 1/148

(57) ABSTRACT

An electric motor includes: a rotor main body supported by a rotary shaft; and a stator. The stator includes: a stator core including a first end surface that is an end surface in an axial direction of the rotary shaft and a second end surface that is another end surface in the axial direction; and a magnetic flux capture member disposed on a core end surface that is at least one of the first end surface or the second end surface. The magnetic flux capture member is made of magnetic material to capture magnetic flux from the rotor main body. The magnetic flux capture member includes at least one of a bent part protruding in a direction away from the rotor main body or a curved part having a concave surface facing inward in a radial direction of the stator.

### CROSS REFERENCE TO RELATED APPLICATION

This application is a U.S. national stage application of PCT/JP2021/011095 filed on Mar. 18, 2021, the contents of which are incorporated herein by reference.

### TECHNICAL FIELD

The present disclosure relates to an electric motor.

### BACKGROUND

An electric motor in which a length of a stator in an axial direction and a length of a permanent magnet in the axial direction are substantially the same is known. See, for example, Patent Reference 1.

### PATENT REFERENCE

Patent Reference 1: Japanese Patent Application Publication No. 2005-198440 (see, e.g., FIG. 1)

However, in the electric motor of Patent Reference 1, when the length of the stator in the axial direction is made less than the length of the permanent magnet in the axial direction in order to reduce the cost of the electric motor, the amount of magnetic flux flowing from the permanent magnet into the stator is reduced and consequently the efficiency of the electric motor is disadvantageously reduced. For that reason, it is contemplated that a magnetic flux capture member made of magnetic material to capture magnetic flux from a permanent magnet is provided on a stator. In this case, it is necessary to facilitate positioning the magnetic flux capture member.

### SUMMARY

It is an object of the present disclosure to facilitate positioning a magnetic flux capture member.

An electric motor according to an aspect of the present disclosure includes: a rotor main body supported by a rotary shaft; and a stator, wherein the stator includes: a stator core including a first end surface that is an end surface in an axial direction of the rotary shaft and a second end surface that is another end surface in the axial direction; a magnetic flux capture member disposed on a core end surface that is at least one of the first end surface or the second end surface, the magnetic flux capture member being made of magnetic material to capture magnetic flux from the rotor main body; and a mold resin molded unitedly with the stator core, and the magnetic flux capture member includes at least one of a bent part protruding in a direction away from the rotor main body or a curved part having a concave surface facing inward in a radial direction of the stator and fixed by the mold resin.

According to the present disclosure, it is possible to facilitate positioning the magnetic flux capture member.

### BRIEF DESCRIPTION OF THE DRAWINGS

FIG. 1 is a cross-sectional view schematically illustrating a configuration of an electric motor according to a first embodiment.

FIG. 2 is a perspective view illustrating a part of a configuration of a stator core of a stator illustrated in FIG. 1.

FIG. 3 is a plan view illustrating a part of a configuration of a stator core illustrated in FIGS. 1 and 2.

FIG. 4A is an enlarged cross-sectional view schematically illustrating a structure of a section B1 in FIG. 1.

FIGS. 4B to 4D are enlarged cross-sectional views schematically illustrating other examples of the structure of the section B1 in FIG. 1.

FIG. 5A is an enlarged cross-sectional view schematically illustrating a part of a configuration of a stator of an electric motor according to a first variation of the first embodiment.

FIGS. 5B to 5D are enlarged cross-sectional views schematically illustrating other examples of a part of the configuration of the stator of the electric motor according to the first variation of the first embodiment.

FIG. 6A is an enlarged cross-sectional view schematically illustrating a part of a configuration of a stator of an electric motor according to a second variation of the first embodiment.

FIGS. 6B to 6D are enlarged cross-sectional views schematically illustrating other examples of a part of the configuration of the stator of the electric motor according to the second variation of the first embodiment.

FIG. 7 is a cross-sectional view schematically illustrating a configuration of an electric motor according to a second embodiment.

FIG. 8A is an enlarged cross-sectional view schematically illustrating a structure of a section B2 illustrated in FIG. 7.

FIGS. 8B to 8D are enlarged cross-sectional views schematically illustrating other examples of the structure of the section B2 illustrated in FIG. 7.

FIG. 9A is an enlarged cross-sectional view schematically illustrating a part of a configuration of a stator of an electric motor according to a first variation of the second embodiment.

FIGS. 9B to 9D are enlarged cross-sectional views schematically illustrating other examples of a part of the configuration of the stator of the electric motor according to the first variation of the second embodiment.

FIG. 10A is an enlarged cross-sectional view schematically illustrating a part of a configuration of a stator of an electric motor according to a second variation of the second embodiment.

FIGS. 10B to 10D are enlarged cross-sectional views schematically illustrating other examples of a part of the configuration of the stator of the electric motor according to the second variation of the second embodiment.

FIG. 11 is a perspective view illustrating a configuration of a stator of an electric motor according to a third embodiment.

FIG. 12 is an enlarged perspective view illustrating a part of a configuration of the stator illustrated in FIG. 11.

FIG. 13A is an enlarged plane view illustrating a part of the configuration of the stator illustrated in FIGS. 11 and 12.

FIG. 13B is cross-sectional view of the part of the configuration of the stator taken along line A13-A13 in FIG. 13A.

FIG. 14 is a perspective view illustrating a configuration of a stator core and an insulator illustrated in FIG. 11 and FIG. 12.

FIG. 15 is an enlarged perspective view illustrating a part of the configuration of the stator core and the insulator illustrated in FIG. 14.

FIG. 16A is a plane view schematically illustrating a configuration of a magnetic flux capture member illustrated in FIG. 13A.

FIGS. 16B to 16D are plane views schematically illustrating other examples of the configuration of the magnetic flux capture member according to the third embodiment.

FIG. 17A is a plane view schematically illustrating a configuration of a magnetic flux capture member according to a first variation of the third embodiment.

FIG. 17B is a plane view schematically illustrating other example of the configuration of the magnetic flux capture member according to the first variation of the third embodiment.

FIG. 18 is a plane view schematically illustrating a configuration of a magnetic flux capture member according to a second variation of the third embodiment.

### DETAILED DESCRIPTION

An electric motor according to the present embodiment will now be described below with reference to the attached drawings. The following embodiments are merely examples, and can be modified in various ways within the scope of the present disclosure.

In order to make it easy to understand the relationships between diagrams, an xyz orthogonal coordinate system shown in each diagram. A z-axis is a coordinate axis parallel to an axis line of a rotor of the electric motor. An x-axis is a coordinate axis orthogonal to the z-axis. A y-axis is a coordinate axis orthogonal to both the x-axis and the z-axis.

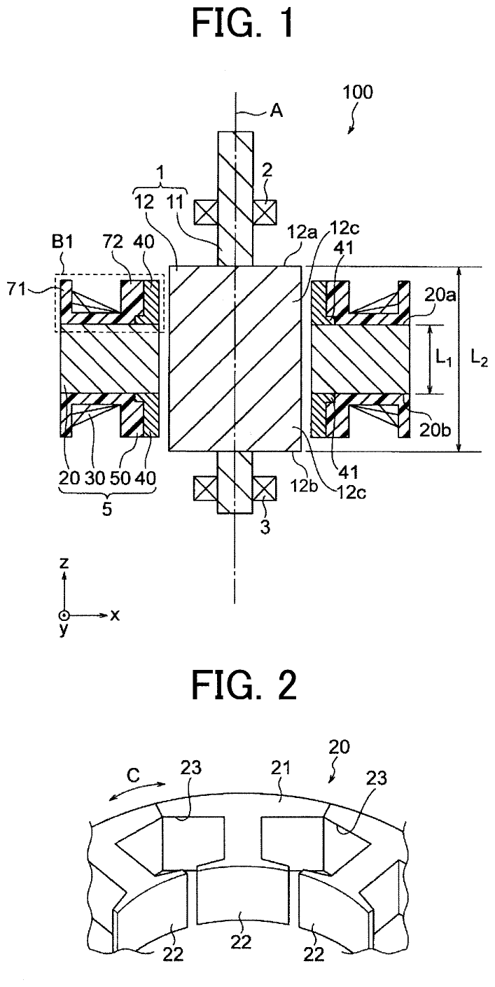

FIG. 1 is a cross-sectional view illustrating a configuration of an electric motor 100 according to a first embodiment. As illustrated in FIG. 1, the electric motor 100 includes a rotor 1, bearings 2 and 3, and a stator 5.

The rotor 1 includes a shaft 11 as a rotary shaft and a permanent magnet 12 as a rotor main body. The rotor 1 can rotate about an axis line A of the shaft 11. The shaft 11 protrudes along the z-axis from the stator 5. A direction along the circumference of a circle about the axis line A of the shaft 11 hereafter will be referred to as a “circumferential direction C.” A z-axis direction is also referred to as an “axial direction,” and a direction orthogonal to the axial direction is referred to as a “radial direction.” A protruding side of the shaft 11 (i.e., +z-axis side) is referred to as a “load side,” and the other side opposite to the load side of the shaft 11 (i.e., −z-axis side) is referred to as an “anti-load side.” The permanent magnet 12 is attached to the shaft 11. In an example illustrated in FIG. 1, the permanent magnet 12 is a cylindrical magnet extending in the z-axis direction. N-poles and S-Poles are formed alternately on an outer peripheral surface of the permanent magnet 12. The rotor main body of the rotor 1 may be composed of a rotor core fixed to the shaft 11, and a permanent magnet fixed to the rotor core.

A bearing 2 is a bearing that supports the load side of the shaft 11, and a bearing 3 is a bearing that supports the anti-load side of the shaft 11.

The stator 5 includes a stator core 20 and a winding 30 wound around the stator core 20.

The stator core 20 includes a first end surface 20a that is one end surface in the axial direction (specifically, an end surface on the +z-axis side) and a second end surface 20b that is the other end surface (specifically, an end surface on the −z-axis side). The permanent magnet 12 described above includes a third end surface 12a that is one end surface in the axial direction (specifically, an end surface on the +z-axis side) and a fourth end surface 12b that is the other end surface (specifically, an end surface on the −z-axis side).

A length L₁ is shorter than a length L₂ where L₁ is a first length (hereafter, also referred to as an “axial length”) that is a length of the stator core 20 in the z-axis direction, and L₂ is a second length that is a length of the permanent magnet 12 in the z-axis direction. That is, the length L₁ and the length L₂ satisfy the following expression (1).

L₁<L₂ (1)

The stator core 20 includes a plurality of electrical steel sheets (not shown) laminated in the z-axis direction. Since the length L₁ is shorter than the length L₂, the number of the electrical steel sheets provided in the stator core 20 is reduced and consequently the cost of the stator core 20 can be reduced. Therefore, the cost of the electric motor 100 can be reduced.

In the first embodiment, the end surface 20a on the +z-axis side and the end surface 20b on the −z-axis side of the stator core 20 are disposed between the end surface 12a on the +z-axis side and the end surface 12b on the −z-axis side of the permanent magnet 12. The electric motor 100 can be achieved even if one or the other of the end surfaces of the end surface 20a on the +z-axis side and the end surface 20b on the −z-axis side is not disposed between the end surface 12a on the +z-axis side and the end surface 12b on the −z-axis side of the permanent magnet 12. The end surface 20b on the −z-axis side of the stator core 20 may be located outward from the end surface 12b on the −z-axis side of the permanent magnet 12 in the axial direction, for example. In the following descriptions, the end surfaces 20a and 20b are also referred to as “core end surfaces.”

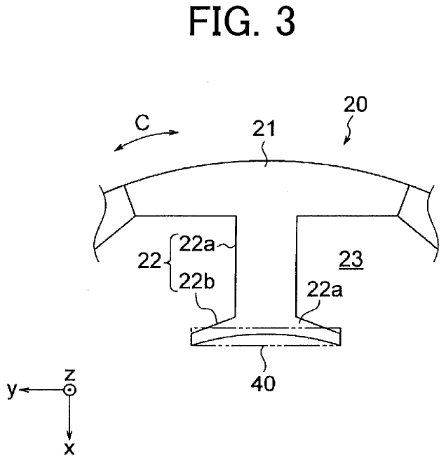

FIG. 2 is a perspective view illustrating a part of a configuration of the stator core 20 illustrated in FIG. 1. FIG. 3 is a plan view illustrating a part of a configuration of the stator core 20 illustrated in FIGS. 1 and 2. As illustrated in FIGS. 2 and 3, the stator core 20 includes a yoke extending in the circumferential direction C and a plurality of teeth 22. The teeth 22 are disposed at predetermined intervals in the circumferential direction C. A slot 23 as a space in which the winding 30 (see, FIG. 1) is accommodated is provided between the two teeth 22, of the plurality of teeth 22, adjoining in the circumferential direction C.

The teeth 22 face the rotor 1 (see, FIG. 1) in the radial direction. Each tooth 22 of the teeth 22 includes a tooth main body 22a and a tooth end part 22b. The tooth main body 22a extends inward in the radial direction from the yoke. The tooth end part 22b disposed inward from the tooth main body 22a in the radial direction and is wider than the tooth main body 22a in the circumferential direction C.

As illustrated in FIG. 1, if the axial length of the stator core 20 in the z-axis direction is shorter than the axial length of the permanent magnet 12 in the z-axis direction, it is contemplated that magnetic flux coming from the ends in the z-axis direction (hereafter, referred to as “overhang parts 12c”), of the permanent magnet 12, that not face the stator core 2 in the radial direction does not easily flow into the stator core 20 and the winding 30. In this manner, if the amount of the magnetic flux flowing into the stator 5 from the permanent magnet 12 is reduced, the efficiency of the electric motor 100 may be reduced.

As illustrated in FIG. 1, the stator 5 includes a magnetic flux capture members 40 disposed on end surfaces 20a and 20b of the stator core 20 in the z-axis direction in the first embodiment. The magnetic flux capture members 40 are made of magnetic material to capture magnetic flux of the permanent magnet 12. With this configuration, the magnetic flux coming from the overhang parts 12c of the permanent magnet 12 easily flows into the stator core 20 and the winding 30 through the magnetic flux capture members 40. This makes it possible to prevent the reduction of the efficiency of the electric motor 100. For that reason, according to the first embodiment, even if a magnet having low magnetic force as the permanent magnet 12 (e.g., a ferrite magnet), for example, the reduction of the efficiency of the electric motor 100 is prevented, and the cost of the electric motor 100 can be reduced.

The magnetic flux capture members 40 are, for example, pieces of metal made of metal. Specifically, the magnetic flux capture members 40 are pieces of iron made of iron.

In the first embodiment, the magnetic flux capture members 40 are disposed on end surfaces 20a and 20b of the stator core 20 on both ends in the z-axis direction. Accordingly, magnetic flux coming from the overhang parts 12c of both end sides of the permanent magnet 12 in the z-axis direction can be captured and consequently the reduction of the efficiency of the electric motor 100 can be further prevented. It should be noted that the stator 5 may include a magnetic flux capture member disposed on one or the other of the core end surfaces of the end surface 20a on the +z-axis side and the end surface 20b on the −z-axis side of the stator core 20. In this case, the number of components in the electric motor 100 is reduced and consequently production processes of the electric motor 100 can be simplified. That is, the magnetic flux capture member 40 has only to be disposed on at least either the end surface 20a on the +z-axis side or the end surface 20b on the −z-axis side of the stator core 20.

As illustrated FIG. 3, the magnetic flux capture member 40 is disposed on the tooth end part 22b of the tooth 22. Accordingly, since the magnetic flux capture member 40 is disposed close to the permanent magnet 12, the magnetic flux from the permanent magnet 12 is easily captured by the magnetic flux capture member 40.

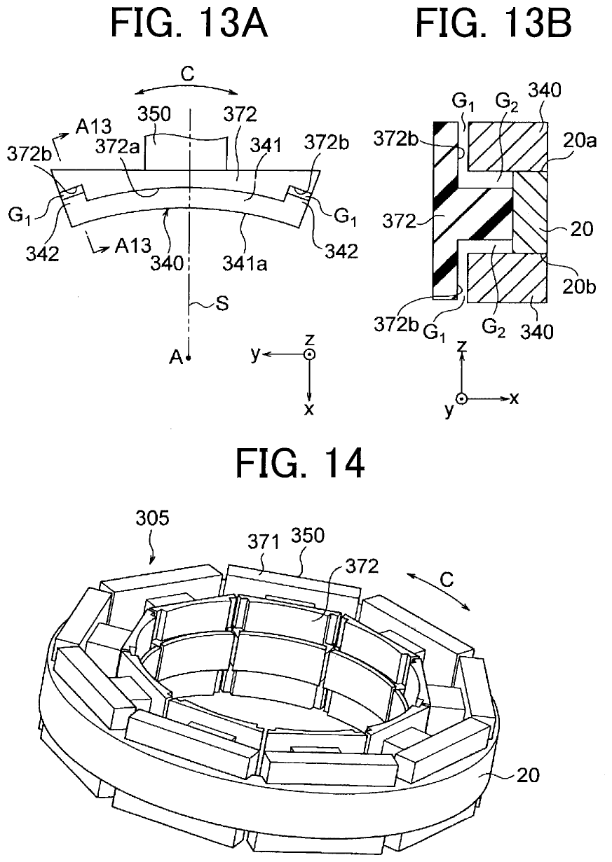

A shape of the magnetic flux capture member 40 as seen in the z-axis direction is, for example, a shape of a rectangle. It should be noted that, as illustrated in FIG. 13A referenced later, or the like, a shape of a magnetic flux capture member 340 as seen in the z-axis direction may be a shape of a curved shape (e.g., a circular arc) having a concave surface 341a facing inward in the radial direction.

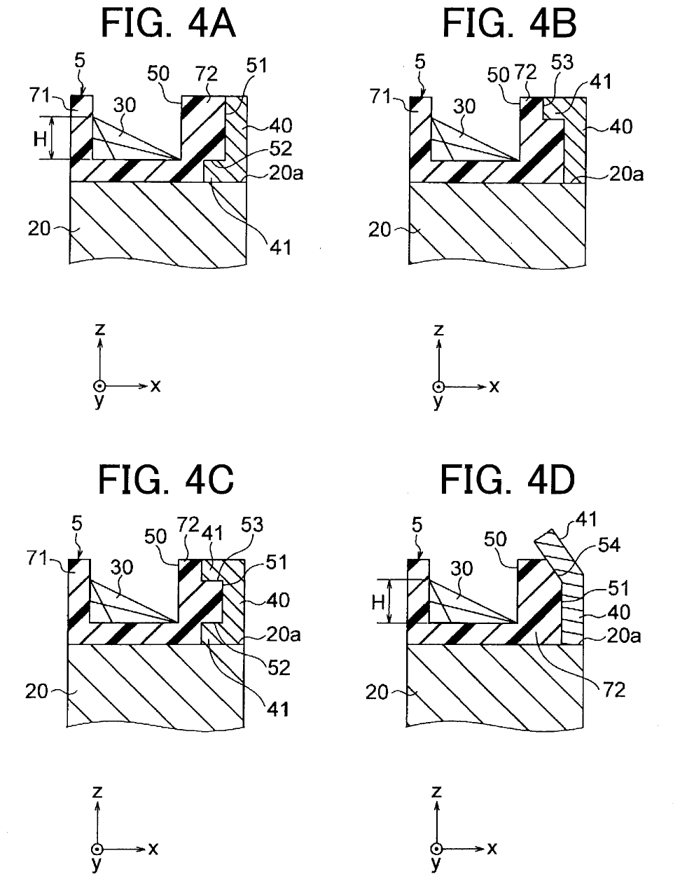

FIG. 4A is an enlarged cross-sectional view schematically illustrating a structure of a section B1 illustrated in FIG. 1. As illustrated in FIG. 1 and FIG. 4A, the magnetic flux capture member 40 includes a bent part 41 protruding in a direction away from the permanent magnet 12 (specifically, a radially outer direction). This makes it possible to facilitate positioning the magnetic flux capture member 40 in fixing the magnetic flux capture member 40 to a fixing member (the insulator 50 in the first embodiment) described later.

In an example illustrated in FIG. 4A, the bent part 41 is provided at the end part on a stator core 20 side of the end parts of the magnetic flux capture member 40 in the z-axis direction. Accordingly, a contact area where the magnetic flux capture member 40 is in contact with the end surface 20a in the z-axis direction of the stator core 20 increases and consequently the strength for fixing the magnetic flux capture member 40 can be improved.

When magnetic flux from a permanent magnet flows into a stator core through a magnetic flux capture member, the magnetic flux density due to the magnetic flux increases disadvantageously as it approaches the stator core. In the first embodiment, as described above, the contact area where the magnetic flux capture member 40 is in contact with the end surface 20a in the z-axis direction of the stator core 20 increases and consequently the increase in the magnetic flux density due to the magnetic flux flowing into the stator core 20 through the magnetic flux capture member 40 can be eased.

In the example illustrated in FIG. 1 and FIG. 4A, the bent part 41 is a part of the magnetic flux capture member 40 in which the end part on the stator core 20 side is bent ninety degrees outward in the radial direction. It should be noted that, as illustrated in FIG. 4B and FIG. 4C referenced later, the bent part 41 may be provided on the end part on the opposite side from the stator core 20. Further, as illustrated in FIG. 4D referenced later, the bent part 41 may be a shape that is inclined outward in the radial direction as the bent part 41 is away from the end surface 20a in the z-axis direction of the stator core.

The stator 5 further includes an insulator 50 as an insulating member insulating the winding 30 and the stator core 20. The insulator 50 is formed of, for example, thermoplastic resin such as Poly Phenylene Sulfide (PPS) and Poly Butylene Terephthalate (PBT).

As illustrated in FIG. 1 and FIG. 4A, the insulator 50 includes a first wall part 71 provided outward from the winding 30 in the radial direction and covering the yoke 21, and a second wall part 72 provided inward from the winding 30 in the radial direction and covering the tooth 22 (e.g., tooth end part 22b).

As illustrated in FIG. 4A, in the first embodiment, since the insulator 50 is in contact with an outer surface 43, in the radial direction, of the magnetic flux capture member 40, the insulator 50 has a function of a fixing member to fix the magnetic flux capture member 40. Accordingly, the stator 5 does not need to have another member to fix the magnetic flux capture member 40. Therefore, the number of components in the electric motor 100 can be reduced.

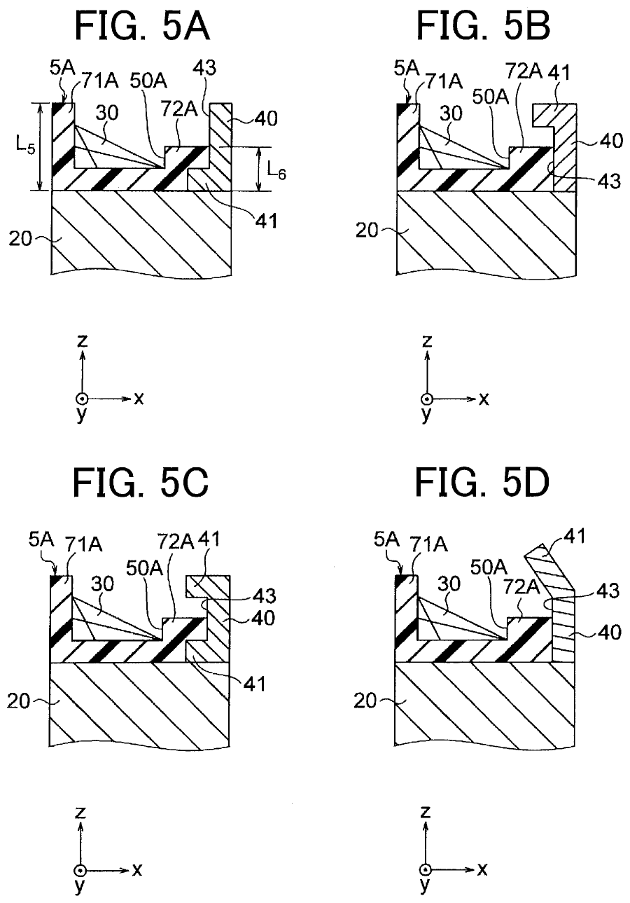

The insulator 50 is in contact with the whole of the outer surface 43 in the radial direction of the magnetic flux capture member 40. In other words, the insulator 50 is in contact with the surface of the magnetic flux capture member 40 on the opposite side from the permanent magnet 12 (see, FIG. 1). This makes it possible to prevent the insulator 50 from obstructing to flow magnetic flux from the permanent magnet 12. In the case where the power of the insulator 50 fixing the magnetic flux capture member 40 is enough, the insulator 50 may be in contact with a part of the outer surface 43 in the radial direction of the magnetic flux capture member 40 as illustrated in FIG. 5A or the like referenced later. That is, the insulator 50 has only to be in contact with at least a part of the outer surface 43 in the radial direction of the magnetic flux capture member 40.

The second wall part 72 of the insulator 50 includes a surface 51 facing inward in the radial direction, and an engagement part 52 provided on the surface 51 facing inward in the radial direction.

The engagement part 52 engages with the bent part 41 of the magnetic flux capture member 40. This makes it possible to facilitate positioning the magnetic flux capture member 40 in fixing the magnetic flux capture member 40 to the insulator 50. In addition, since a contact area where the magnetic flux capture member 40 is in contact with the insulator 50 increases, the strength for fixing the magnetic flux capture member 40 can be further improved. In the first embodiment, the engagement part 52 is, for example, a level difference part (hereafter, also referred to as a “depression part”) provided by cutting an end part of the surface 51 facing inward in the radial direction on the stator core 20 side, and the bent part 41 is fitted to the depression part.

When the winding is wound around the tooth 22 with the insulator 50 in between, stress due to the effect of the tension of the winding (hereafter, also referred to as “winding stress”) is generated in the insulator 50. In the first embodiment, the height H of a coil end part of the winding 30 becomes low toward the inner side in the radial direction from the end of the coil end part. Accordingly, in the insulator 50, the winding stress generated in the second wall part 72 supporting the magnetic flux capture member 40 is smaller than the winding stress generated in the first wall part 71. Therefore, the deformation of the inner side of the insulator 50 in the radial direction due to the winding stress can be prevented.

In the first embodiment, the height H of the coil end part becomes low toward the inner side from the outer side in the radial direction of the winding 30. The height H is a height of the coils stacked on the end side of the tooth 22 in the z-axis direction by winding the coils around the tooth 22. It should be noted that the height H of the coil end part of the winding 30 may be the highest at the center in the radial direction of the winding 30 and become low toward the inner side or the outer side in the radial direction from the center.

FIGS. 4B to 4D are enlarged cross-sectional views schematically illustrating other examples of the structure of the section B1 in FIG. 1. The bent part 41 does not necessarily need to be a structure in which the end part of the magnetic flux capture member 40 on the stator core 20 side is bent.

As illustrated in FIG. 4B, for example, the magnetic flux capture member 40 may include the bent part 41 that is the end part of the magnetic flux capture member 40 on the opposite side from the stator core 20 (i.e., the end part on the +z-axis side) is bent. In this case, the insulator 50 includes an engagement part 53 provided on the end part on the +z-axis side of the surface 51 facing inward in the radial direction. The engagement part 53 engages with the bent part 41. This makes it possible to facilitate positioning the magnetic flux capture member 40 in fixing the magnetic flux capture member 40 to the insulator 50. Further, in the example illustrated in FIG. 4B, the magnetic flux capture member 40 can be engaged with the insulator 50 after molding the insulator 50 and consequently the productivity of the stator 5 can be improved. In addition, a contact area where the magnetic flux capture member 40 is in contact with the insulator 50 increases and consequently the strength for fixing the magnetic flux capture member 40 can be improved.

In addition, as illustrated in FIG. 4C, the magnetic flux capture member 40 may include a plurality of bent parts 41 that are both end parts in the z-axis direction of the magnetic flux capture member 40 are bent. Accordingly, a contact area where the magnetic flux capture member 40 is in contact with the insulator 50 further increases and consequently the strength for fixing the magnetic flux capture member 40 can be further improved.

In addition, as illustrated in FIG. 4D, the bent part 41 may be inclined in the direction (i.e., outward in the radial direction) away from the permanent magnet 12 (see, FIG. 1) as the bent part 41 is away from the end surface 20a in the z-axis direction of the stator core 20. Accordingly, the contact area where the magnetic flux capture member 40 is in contact with the insulator 50 increases and consequently the strength for fixing the magnetic flux capture member 40 can be improved. An end part 54 on the +z-axis side of the surface 51 facing inward in the radial direction of the insulator 50 is an inclined plane that is inclined outward in the radial direction as the end part 54 is away from the end surface 20a in the z-axis direction of the stator core 20.

In addition, the height H of the coil end part of the winding 30 becomes high toward the outer side from the inner side in the radial direction in the first embodiment. In the case where the shape of the bent part 41 as seen in a z-x cross-sectional view is an inclined shape described above, the distance between the winding 30 and the bent part 41 can be uniform. Therefore, the magnetic flux captured by the magnetic flux capture member 40 easily flows into the winding 30.

Further, since the bent part 41 is inclined in the direction away from the permanent magnet 12, the magnetic flux capture member 40 does not easily come off the insulator 50 even if magnetic suction is generated between the bent part 41 and the permanent magnet 12 during rotation. It should be noted that the structure of the magnetic flux capture member 40 may be a combination of the structures illustrated in FIG. 4A and FIG. 4D.

### Advantage of the First Embodiment

According to the first embodiment described above, the electric motor 100 includes the rotor 1 including the permanent magnet 12, and the stator 5 including the stator core 20. The length L₁ of the stator core 20 in the z-axis direction is shorter than the length L₂ of the permanent magnet 12 in the z-axis direction. This makes it to reduce the number of the electrical steel sheets used for the stator core 20 and consequently the cost of the stator 5 can be reduced. Therefore, the cost of the electric motor 100 can be reduced.

According to the first embodiment, the stator 5 includes the magnetic flux capture members 40 disposed on the end surfaces 20a and 20b of the stator core 20 in the z-axis direction and made of magnetic material to capture magnetic flux of the permanent magnet 12. With this configuration, the magnetic flux coming from the overhang parts 12c of the permanent magnet 12 flows into the stator core 20 and the winding 30 through the magnetic flux capture members 40. This makes it possible to prevent the reduction of the amount of the magnetic flux flowing into the stator 5 from the permanent magnet 12. Therefore, the reduction of the amount of the magnetic flux flowing into the stator 5 from the permanent magnet 12 can be prevented with the cost kept down in the electric motor 100.

According to the first embodiment, the magnetic flux capture member 40 includes a bent part 41 protruding in the direction away from the permanent magnet 12. This makes it possible to facilitate positioning the magnetic flux capture member 40 in fixing the magnetic flux capture member 40 to the insulator 50.

According to the first embodiment, the bent part 41 is a part of the magnetic flux capture member 40 in which the end part on the stator core 20 side is bent. Accordingly, the contact area where the magnetic flux capture member 40 is in contact with the stator core 20 increases and consequently the strength for fixing the magnetic flux capture member 40 can be improved. In addition, the increase in the magnetic flux density due to the magnetic flux flowing into the stator core 20 through the magnetic flux capture member 40 can be eased.

According to the first embodiment, the stator 5 includes the insulator 50 insulating the winding 30 and the stator core 20, and the insulator 50 functions as a fixing member to fix the magnetic flux capture member 40. Accordingly, the stator 5 does not need to have another member to fix the magnetic flux capture member 40. Therefore, the number of components in the electric motor 100 can be reduced.

According to the first embodiment, the insulator 50 includes the engagement part 52 that engages with the bent part 41. This makes it possible to facilitate positioning the magnetic flux capture member 40. In addition, since the contact area where the magnetic flux capture member 40 is in contact with insulator 50 increases, the strength for fixing the magnetic flux capture member 40 can be improved.

### First Variation of First Embodiment

FIG. 5A is an enlarged cross-sectional view schematically illustrating a configuration of a stator 5A of an electric motor according to a first variation of the first embodiment. In FIG. 5A, each component identical or corresponding to a component illustrated in FIG. 4A is assigned the same reference character as those in FIG. 4A. The electric motor according to the first variation of the first embodiment is different in a shape of an insulator 50A of the stator 5A from the electric motor 100 according to the first embodiment. With respect to the other points, the electric motor according to the first variation of the first embodiment is the same as the electric motor 100 according to the first embodiment. For that reason, FIG. 1 and FIG. 2 will now be referenced in the following explanations.

As illustrated in FIG. 5A, the stator 5A of the electric motor includes the stator core 20, the winding 30, the magnetic flux capture member 40, and the insulator 50A.

The insulator 50A includes a first wall part 71A that is provided outward in the radial direction from the winding 30 (see, FIG. 1) and covers the yoke 21 (see, FIG. 2), and a second wall part 72A that is provided inward in the radial direction from the winding 30 and covers the tooth 22 (see, FIG. 2).

In the first variation of the first embodiment, the insulator 50A is in contact with a part (specifically, an end part on the −z-axis side) of an outer surface 43 in the radial direction of the magnetic flux capture member 40. In other words, a length L₆ is shorter than a length L₅ where L₅ is the length of the first wall part 71A in the z-axis direction and L₆ is the length of the second wall part 72A in the z-axis direction of the insulator 50A. Accordingly, the amount of the thermoplastic resin that is a material of the insulator 50A is reduced and consequently the cost of the electric motor can be reduced.

FIGS. 5B to 5D are enlarged cross-sectional views schematically illustrating other examples of a part of the configuration of the stator 5A of the electric motor according to the first variation of the first embodiment. A shape of the insulator 50A is not limited to the shape illustrated in FIG. 5A and may be modified properly so as to meet a shape of the magnetic flux capture member 40. The shapes of the magnetic flux capture members 40 illustrated in FIGS. 5B to 5D are the same as the shapes of the magnetic flux capture members 40 illustrated in FIGS. 4B to 4D respectively. Each insulator 50A in FIGS. 5B to 5D is also in contact with the end part on the −z-axis side that is a part of the outer surface 43 in the radial direction of the magnetic flux capture member 40.

### Advantage of First Variation of First Embodiment

According to the first variation of the first embodiment described above, each insulator 50A is in contact with a part of the outer surface 43 in the radial direction of the magnetic flux capture member 40. Accordingly, the amount of the thermoplastic resin that is a material of the insulator 50A is reduced and consequently the cost of the electric motor can be reduced.

### Second Variation of First Embodiment

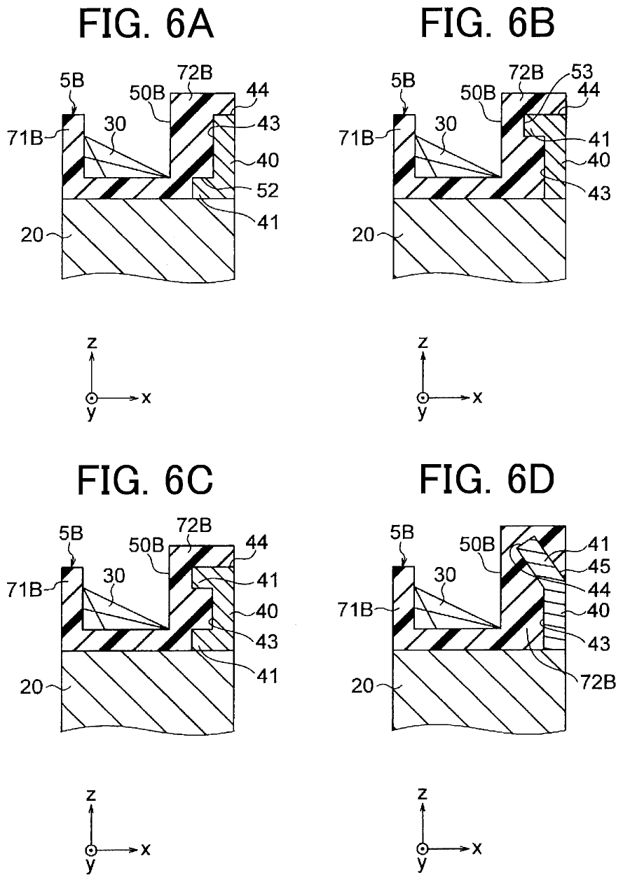

FIG. 6A is an enlarged cross-sectional view schematically illustrating a part of a configuration of a stator 5B of an electric motor according to a second variation of the first embodiment. In FIG. 6A, each component identical or corresponding to a component illustrated in FIG. 4A is assigned the same reference character as those in FIG. 4A. The electric motor according to the second variation of the first embodiment is different in a shape of an insulator 50B of the stator 5B from the electric motor according to the first embodiment. With respect to the other points, the electric motor according to the second variation of the first embodiment is the same as the electric motor 100 according to the first embodiment. For that reason, FIG. 1 and FIG. 2 will now be referenced in the following explanations.

As illustrated in FIG. 6A, the stator 5B of the electric motor includes the stator core 20, the winding 30, the magnetic flux capture member 40, and the insulator 50B.

The insulator 50B includes a first wall part 71B that is provided outward in the radial direction from the winding 30 (see, FIG. 1) and covers the yoke 21 (see, FIG. 2), and a second wall part 72B that is provided inward in the radial direction from the winding 30 and covers the tooth 22 (see, FIG. 2).

The second wall part 72B of the insulator 50B is in contact with the whole of the outer surface 43 in the radial direction of the magnetic flux capture member 40. The second wall part 72B of the insulator 50B is in contact with an end part 44, which is an end part on an opposite side from the stator core 20, of the magnetic flux capture member 40 in the z-axis direction. Accordingly, a contact area where the magnetic flux capture member 40 is in contact with the insulator 50B further increases and consequently the strength for fixing the magnetic flux capture member 40 can be further improved.

FIGS. 6B to 6D are enlarged cross-sectional views schematically illustrating other examples of a part of the configuration of the stator 5B of the electric motor according to the second variation of the first embodiment. A shape of the insulator 50B is not limited to the shape illustrated in FIG. 6A and may be modified properly so as to meet a shape of the magnetic flux capture member 40. The shapes of the magnetic flux capture members 40 illustrated in FIGS. 6B to 6D are the same as the shapes of the magnetic flux capture members 40 illustrated in FIGS. 4B to 4D respectively. Each insulator 50B in FIGS. 6B to 6D is also in contact with the end part 44 on an opposite side from the stator core 20, of end parts of the magnetic flux capture member 40 in the z-axis direction.

In the example illustrated in FIG. 6D, the second wall part 72B of the insulator 50B is also in contact with an inner surface 45 in the radial direction of the bent part 41. With this configuration, the bent part 41 is covered with the insulator 50B. In other words, the insulator 50B exists between the bent part 41 and the permanent magnet 12 (see, FIG. 1) in the radial direction. Accordingly, even if magnetic suction is generated between the bent part 41 and the permanent magnet 12 during rotation, the magnetic flux capture member 40 does not easily come off the stator core 20.

### Advantage of Second Variation of First Embodiment

According to the second variation of the first embodiment described above, each insulator 50B is in contact with the end part 44, which is an end part on an opposite side from the stator core 20, of the magnetic flux capture member 40 in the z-axis direction. Accordingly, the contact area where the magnetic flux capture member 40 is in contact with the insulator 50B further increases and consequently the strength for fixing the magnetic flux capture member 40 can be further improved.

### Second Embodiment

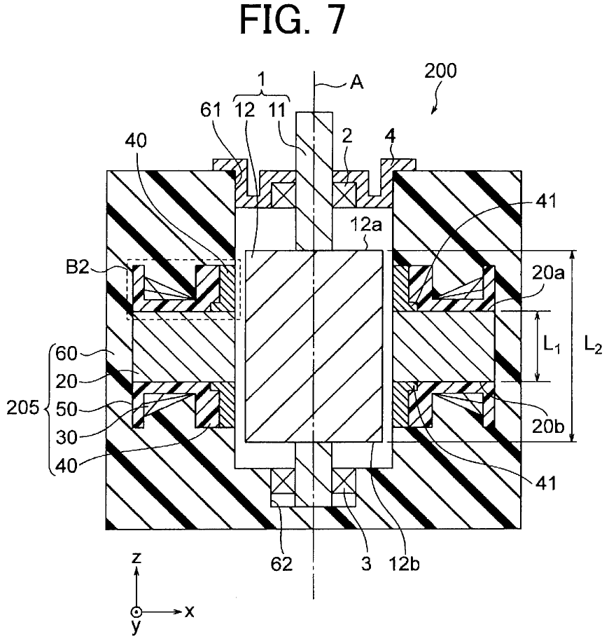

FIG. 7 is a cross-sectional view schematically illustrating a configuration of an electric motor 200 according to a second embodiment. In FIG. 7, each component identical or corresponding to a component illustrated in FIG. 1 is assigned the same reference character as those in FIG. 1. The electric motor 200 according to the second embodiment is different from the electric motor 100 according to the first embodiment in that a stator includes a mold resin 60. With respect to the other points, the electric motor 200 according to the second embodiment is the same as the electric motor 100 according to the first embodiment.

As illustrated in FIG. 7, the electric motor 200 includes the rotor 1, the bearings 2 and 3, a metal bracket 4 as a bearing supporting member, and a mold stator 205 as a stator.

The metal bracket 4 holds the bearing 2 on a load side. The metal bracket 4 is formed of, for example, a steel plate.

The mold stator 205 includes the stator core 20, the winding 30, the magnetic flux capture members 40, the insulator 50, and a mold resin 60.

The mold resin 60 is formed of, for example, thermosetting resin. The mold resin 60 is molded by, for example, ejection molding. The stator core 20, the winding 30, the magnetic flux capture members 40, and the insulator 50 are united with the mold resin 60 by solid casting.

The mold resin 60 includes an opening 61 and a bearing holding part 62. The metal bracket 4 is fixed to the opening 61. The bearing holding part 62 is a concave part in which the bearing 3 on an anti-load side in the mold resin 60 is held.

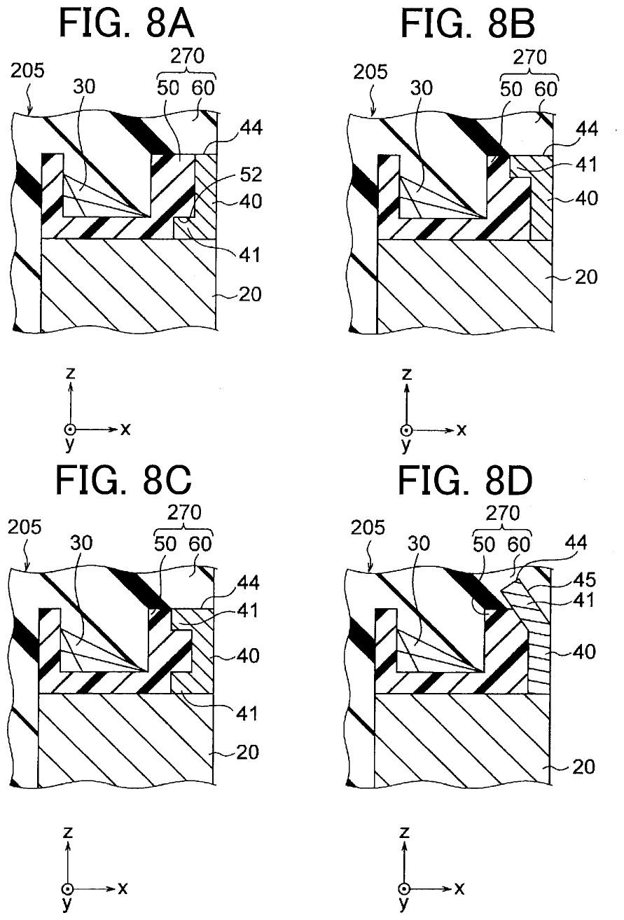

FIG. 8A is an enlarged cross-sectional view schematically illustrating a structure of a section B2 illustrated in FIG. 7. As illustrated in FIG. 8A, the mold resin 60 is in contact with the end part 44 of the magnetic flux capture member 40 in the z-axis direction. In other words, the mold resin 60 covers the end surface of the magnetic flux capture member 40 in the z-axis direction. Accordingly, the strength for fixing the magnetic flux capture member 40 with respect to the stator core 20 can be further improved. That is, in the second embodiment, a fixing member 270 that fixes the magnetic flux capture member 40 is composed of the insulator 50 and the mold resin 60. It should be noted that the fixing member 270 can be achieved by being composed of only the mold resin 60. That is, the fixing member 270 has only to include at least either the insulator 50 or the mold resin 60.

In addition, since the mold resin 60 covers the end surface of the magnetic flux capture member 40 in the z-axis direction, vibration of the magnetic flux capture member 40 due to the magnetic suction generated between the permanent magnet 12 (see, FIG. 7) and the magnetic flux capture member 40 during rotation can be prevented. Therefore, vibration and noise in the electric motor 200 can be prevented.

In addition, as described above, the mold resin 60 is formed of thermosetting resin. On the other hand, as described in the first embodiment, the insulator 50 is formed of thermoplastic resin. The thermosetting resin is harder than the thermoplastic resin. Accordingly, since the deformation of the mold resin 60 is prevented, the magnetic flux capture member 40 does not easily come off the stator core 20 even if stress is generated in the mold resin 60. Further, the thermosetting resin is inexpensive compared with the thermoplastic resin and consequently the cost of the fixing member 270 is reduced.

FIGS. 8B to 8D are enlarged cross-sectional views schematically illustrating other examples of the structure of the section B2 illustrated in FIG. 7. The mold resin 60 may fix not only the magnetic flux capture member 40 illustrated in FIG. 8A but also the magnetic flux capture member 40 illustrated in FIGS. 8B to 8D. The shapes of the magnetic flux capture members 40 illustrated in FIGS. 8B to 8D are the same as the shapes of the magnetic flux capture members 40 illustrated in FIGS. 4B to 4D respectively. Each mold resin 60 in FIGS. 8B to 8D is also in contact with the end part 44 on an opposite side from the stator core 20, of end parts of the magnetic flux capture member 40 in the z-axis direction.

In the example illustrated in FIG. 8D, the mold resin 60 is also in contact with the inner surface 45 in the radial direction of the bent part 41. With this configuration, the bent part 41 is covered with the mold resin 60. In other words, the insulator 50B exists between the bent part 41 and the permanent magnet 12 (see, FIG. 1) in the radial direction. Accordingly, even if magnetic suction is generated between the bent part 41 and the permanent magnet 12 during rotation, the magnetic flux capture member 40 does not more easily come off the stator core 20.

### Advantage of the Second Embodiment

According to the second embodiment described above, the fixing member 270 that fixes the magnetic flux capture member 40 is composed of the insulator 50 and the mold resin 60. The mold resin 60 is in contact with the end part 44 of the magnetic flux capture member 40 in the z-axis direction. Accordingly, the strength for fixing the magnetic flux capture member 40 with respect to the stator core 20 can be further improved. Further, the vibration of the magnetic flux capture member 40 due to the magnetic suction can be prevented. Therefore, vibration and noise in the electric motor 200 can be prevented.

According to the second embodiment, the mold resin 60 is formed of thermosetting resin. The thermosetting resin is harder than the thermoplastic resin that is a material of the insulator 50. Accordingly, since the deformation of the mold resin 60 is prevented, the magnetic flux capture member 40 does not easily come off the stator core 20 even if stress is generated in the mold resin 60. Further, the thermosetting resin is inexpensive compared with the thermoplastic resin and consequently the cost of the fixing member 270 is reduced.

### First Variation of the Second Embodiment

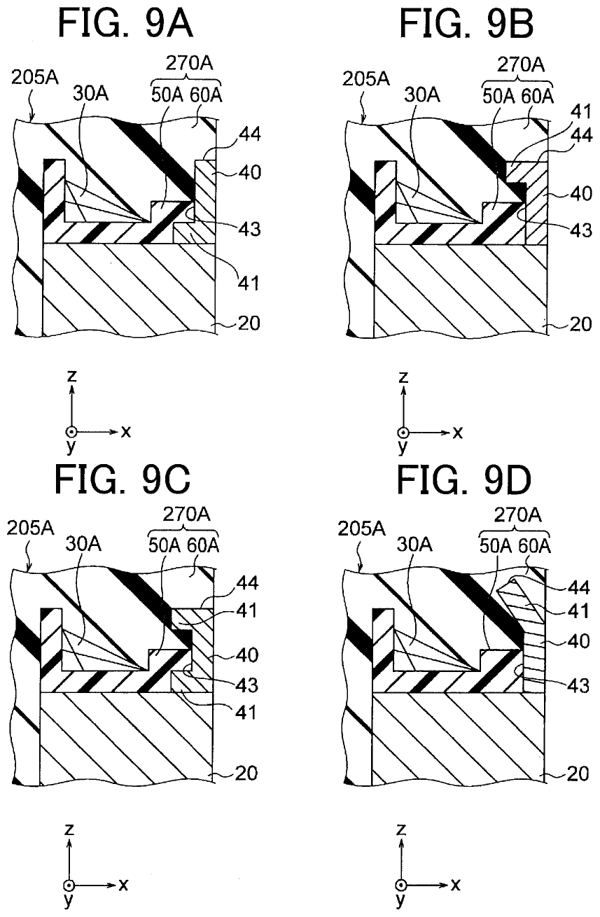

FIG. 9A is an enlarged cross-sectional view schematically illustrating a part of a configuration of a mold stator 205A of an electric motor according to a first variation of the second embodiment. In FIG. 9A, each component identical or corresponding to a component illustrated in FIG. 5A and FIG. 8A is assigned the same reference character as those in FIG. 5A and FIG. 8A. The electric motor according to the first variation of the first embodiment is different in a shape of the insulator 50A of the mold stator 205A from the electric motor 200 according to the second embodiment. In addition, the electric motor according to the first variation of the second embodiment is different in a contact point between the mold resin 60A and the magnetic flux capture member 40 from the electric motor 200 according to the second embodiment. With respect to the other points, the electric motor according to the first variation of the second embodiment is the same as the electric motor 200 according to the second embodiment.

As illustrated in FIG. 9A, the mold stator 205A includes the stator core 20, the winding 30, the magnetic flux capture member 40, and the mold resin 60A.

The mold resin 60A is in contact with the end part 44 of the magnetic flux capture member 40 in the z-axis direction. Accordingly, the strength for fixing the magnetic flux capture member 40 with respect to the stator core 20 can be improved.

In the example illustrated in FIG. 9A, the mold resin 60A is in contact with a part, of the outer surface 43 in the radial direction of the magnetic flux capture member 40, different from a part with which the first wall part 71 of the insulator 50A is in contact. Accordingly, the amount of the thermoplastic resin that is a material of the insulator 50A is reduced, and the strength for fixing the magnetic flux capture member 40 can be improved.

FIGS. 9B to 9D are enlarged cross-sectional views schematically illustrating other examples of a part of the configuration of the mold stator 205A of the electric motor according to the first variation of the second embodiment. The mold resin 60A may fix not only the magnetic flux capture member 40 illustrated in FIG. 9A but also the magnetic flux capture member 40 illustrated in FIGS. 9B to 9D. The shapes of the magnetic flux capture members 40 illustrated in FIGS. 9B to 9D are the same as the shapes of the magnetic flux capture members 40 in the first embodiment illustrated in FIGS. 4B to 4D respectively. The shapes of the insulators 50A illustrated in FIGS. 9B to 9D are the same as the shapes of the insulators 50A in the first variation of the first embodiment illustrated in FIGS. 5B to 5D respectively.

Each mold resin 60A in FIGS. 9B to 9D is also in contact with the end part 44 on an opposite side from the stator core 20, of end parts of the magnetic flux capture member 40 in the z-axis direction. In addition, the mold resin 60A is in contact with a part, of the outer surface 43 in the radial direction of the magnetic flux capture member 40, different from a part with which the first wall part 71 of the insulator 50A is in contact.

### Advantage of First Variation of Second Embodiment

According to the first variation of the second embodiment, the mold resin 60A is in contact with a part, of the outer surface 43 in the radial direction of the magnetic flux capture member 40, different from a part with which the first wall part 71 of the insulator 50A is in contact. Accordingly, in compared with a configuration in which an insulator is in contact with the whole of the outer surface 43 in the radial direction of the magnetic flux capture member 40 (e.g., configurations illustrated in FIG. 4A to FIG. 4D described above), the amount of the thermoplastic resin that is a material of the insulator 50A is reduced, and the strength for fixing the magnetic flux capture member 40 can be improved.

### Second Variation of Second Embodiment

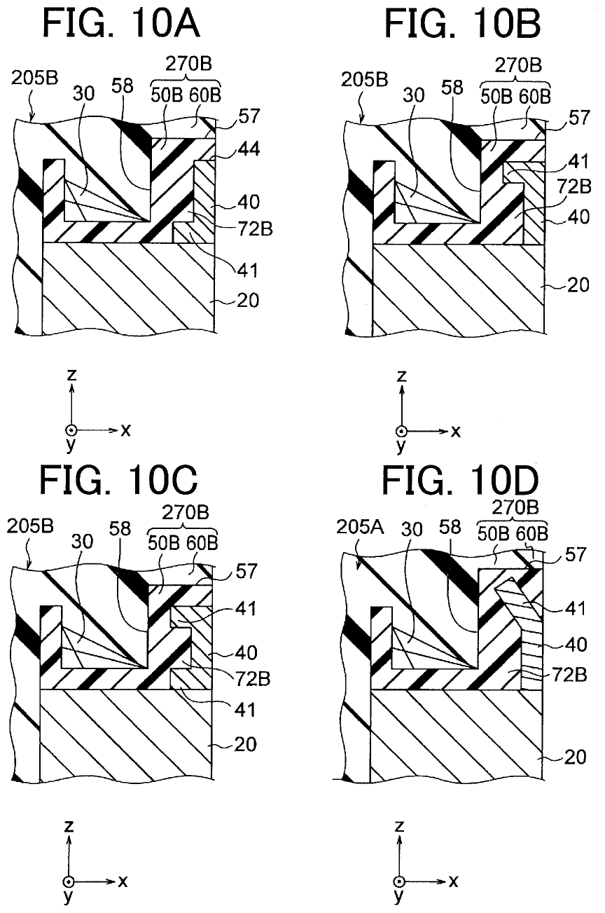

FIG. 10A is an enlarged cross-sectional view schematically illustrating a part of a configuration of a mold stator 205B of an electric motor according to a second variation of the second embodiment. In FIG. 10A, each component identical or corresponding to a component illustrated in FIG. 6A and FIG. 8A is assigned the same reference character as those in FIG. 6A and FIG. 8A. The electric motor according to the second variation of the second embodiment is different from the electric motor 200 according to the second embodiment in that a mold resin 60B covers the insulator 50B. With respect to the other points, the electric motor according to the second variation of the second embodiment is the same as the electric motor 200 according to the second embodiment.

As illustrated in FIG. 10A, the mold stator 205B includes the stator core 20, the winding 30, the magnetic flux capture members 40, the insulator 50B, and the mold resin 60B.

The mold resin 60B covers an end surface 57 in the z-axis direction and a surface 58 facing outward in the radial direction of the second wall part 72B of the insulator 50B. Accordingly, the strength for fixing the insulator 50B is improved and consequently the strength for fixing the magnetic flux capture member 40 fixed to the insulator 50B can also be improved.

FIGS. 10B to 10D are enlarged cross-sectional views schematically illustrating other examples of a part of the configuration of the mold stator 205B of the electric motor according to the second variation of the second embodiment. The insulator 50B may cover not only the insulator 50B illustrated in FIG. 10A but also the insulator 50B illustrated in FIGS. 10B to 10D. The shapes of the insulators 50B illustrated in FIGS. 10B to 10D are the same as the shapes of the insulators 50B of the second variation of the first embodiment illustrated in FIGS. 6B to 6D respectively. Each mold resin 60B in FIGS. 10B to 10D also covers the end surface 57 in the z-axis direction and the surface 58 facing outward in the radial direction of the second wall part 72B of the insulator 50B.

Advantage of second variation of second embodiment According to the second variation of the second embodiment, the end surface 57 in the z-axis direction and the surface 58 facing outward in the radial direction of the second wall part 72B of the insulator 50B are covered. Accordingly, the strength for fixing the insulator 50B with respect to the stator core 20 is improved and consequently the strength for fixing the magnetic flux capture member 40 fixed to the insulator 50B can be further improved.

### Third Embodiment

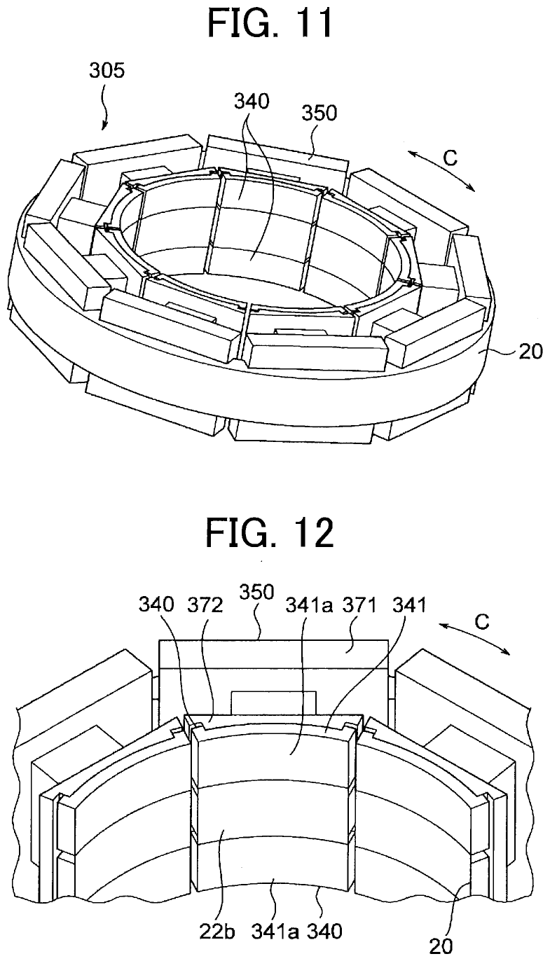

FIG. 11 is a perspective view illustrating a configuration of a stator 305 of an electric motor according to a third embodiment. FIG. 12 is an enlarged perspective view illustrating a part of a configuration of the stator 305 illustrated in FIG. 11. In FIG. 11 and FIG. 12, each component identical or corresponding to a component illustrated in FIG. 1 is assigned the same reference character as those in FIG. 1. The electric motor according to the third embodiment is different in shapes of a magnetic flux capture member 340 and an insulator 350 of the stator 305 from the electric motor 100 according to the first embodiment. With respect to the other points, the electric motor according to the third embodiment is the same as the electric motor 100 according to the first embodiment. For that reason, FIG. 1 will now be referenced in the following explanations.

As illustrated in FIG. 11 and FIG. 12, the stator 305 includes the stator core 20, the winding 30 (see, FIG. 1), the magnetic flux capture member 340, and the insulator 350.

FIG. 13A is an enlarged plane view illustrating a part of the configuration of the stator 305 illustrated in FIG. 11 and FIG. 12. FIG. 13B is cross-sectional view of the part of the configuration of the stator 305 taken along line A13-A13 in FIG. 13A. As illustrated in FIG. 13B, the magnetic flux capture members 340 are disposed on the end surfaces 20a and 20b of the stator core 20 in the z-axis direction. This makes it possible to capture the magnetic flux that flows into the stator core 305 from the overhang parts 12c of the permanent magnet 12 (see, FIG. 1) and consequently the reduction of the efficiency of the electric motor can be further prevented.

As illustrated in FIG. 13A, the magnetic flux capture member 340 includes a curved part 341 having a concave surface 341a facing inward in the radial direction. The shape of the curved part 341 as seen in the z-axis direction is, for example, a circular arc. Accordingly, in compared with a configuration in which a shape of a magnetic flux capture member as seen in the z-axis direction is a shape of a rectangle, a contact area where the magnetic flux capture member 340 is in contact with the stator core 20 increases and consequently the strength for fixing the magnetic flux capture member 340 can be improved.

The curved part 341 is in contact with the insulator 350 (specifically, a second wall part 372 described later). This makes it possible to facilitate positioning the magnetic flux capture member 340. It should be noted that the structure of the magnetic flux capture member 340 may be the structure in which the curved part 341 and the bent part 41 illustrated in FIGS. 4A to 4D described above are combined.

The magnetic flux capture member 340 includes protruding parts 342 that are additional bent parts protruding from the ends in the circumferential direction C of the curved part 341 in the direction away from the permanent magnet 12 (see, FIG. 1). In the example illustrated in FIG. 13A, the protruding parts 342 provided both sides in the circumferential direction C of the curved part 341. In addition, in the example illustrated in FIG. 13A, each protruding part 342 protrudes outward in the radial direction so that the magnetic flux capture member 340 widens in the circumferential direction C. Accordingly, even if magnetic suction is generated between the permanent magnet 12 and the magnetic flux capture member 340 during rotation, the magnetic flux capture member 340 does not easily come off. Therefore, the reliability of the electric motor can be improved.

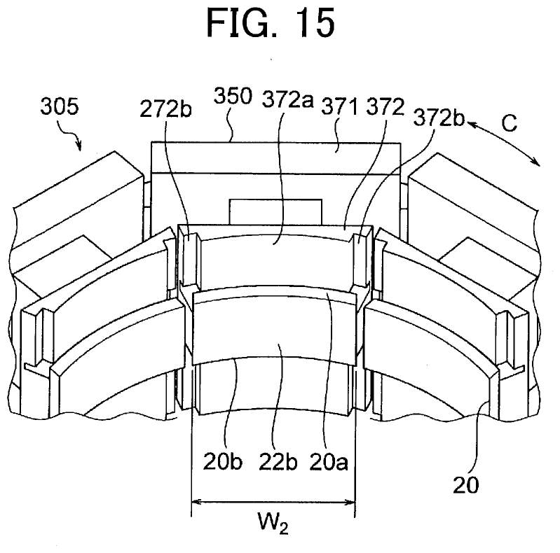

FIG. 14 is a perspective view illustrating a configuration of the stator core 20 and the insulator 350 illustrated in FIG. 11 and FIG. 12. FIG. 15 is an enlarged perspective view illustrating a part of the configuration of the stator core 20 and the insulator 50 illustrated in FIG. 14. As illustrated in FIG. 14 and FIG. 15, the insulator 350 includes a first wall part 371 provided outward from the winding 30 in the radial direction and covering the yoke 21, and a second wall part 372 provided inward from the winding 30 in the radial direction (see, FIG. 1) and covering the tooth 22.

As illustrated in FIG. 13A and FIG. 15, the second wall part 372 includes a first part 372a and second parts 372b. The first part 372a is in contact with the center in the circumferential direction C of the magnetic flux capture member 340 (specifically, the curved part 341). The second parts 372b are provided on the ends (specifically, the protruding part 342) in the circumferential direction C of the magnetic flux capture member 340 with first gaps G1 in between in the radial directions.

The position of the magnetic flux capture member 340 in the radial direction is determined by the contact between the center in the circumferential direction C of the magnetic flux capture member 340 and the first part 372a. For that reason, since the second parts 372b are provided across from the protruding parts 342 with the first gaps G1 in between in the radial directions, the interference in positioning the magnetic flux capture members 340 in the radial direction between the second wall part 372 of the insulator 350 and the protruding part 342 can be prevented.

In addition, as illustrated in FIG. 13B, the second wall part 372 of the insulator 350 is provided across from the magnetic flux capture members 340 with second gaps G₂ in between in the axial direction. The position of the magnetic flux capture member 340 in the axial direction is determined by the contact between the magnetic flux capture members 340 and the stator core 20. Since the insulator 350 is provided across from the magnetic flux capture members 340 with the second gaps G₂ in between in the axial direction, the interference in positioning the magnetic flux capture members 340 in the axial direction between the insulator 350 and the magnetic flux capture members 340 can be prevented.

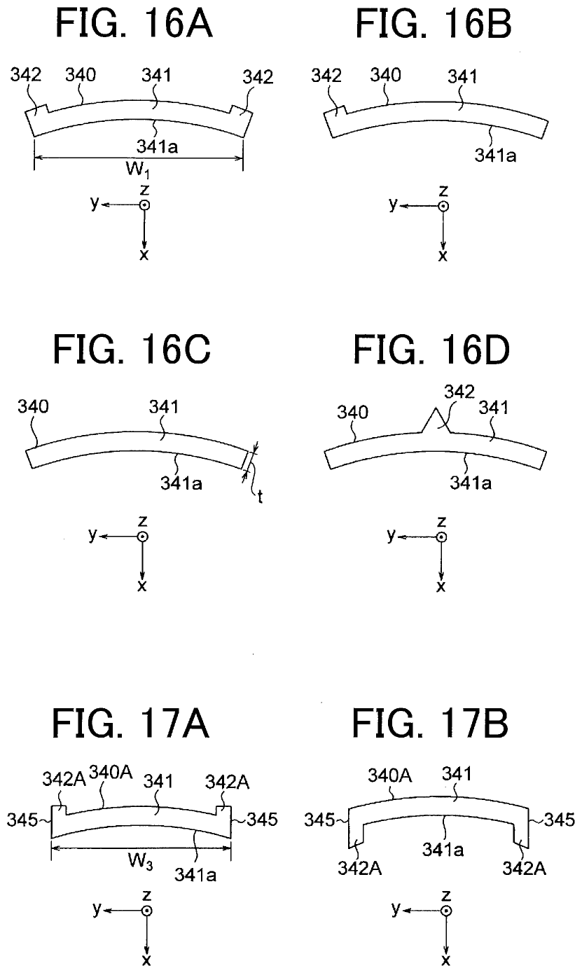

FIG. 16A is a plane view schematically illustrating the configuration of the magnetic flux capture member 340. In FIG. 16A, a width W₁ is narrower than a width W₂, where W₁ is a width of the magnetic flux capture member 340 in the circumferential direction C and W₂ is a width of the tooth end part 22b in the circumferential direction C in FIG. 15 described above. That is, the width W₁ and the width W₂ satisfy the following expression (2).

W₁<W₂ (2)

Accordingly, the interference between the two magnetic flux capture members 340 adjoining in the circumferential direction C can be prevented. It should be noted that the width W₁ and the width W₂ are width in a direction perpendicular to a straight line S, where S is a straight line that is perpendicular to the axis line A of the shaft 11 (see, FIG. 1) and connects the axis line A and the center in the circumferential direction C of the magnetic flux capture member 340 in FIG. 13A.

FIGS. 16B to 16D are plane views schematically illustrating other examples of the configuration of the magnetic flux capture member 340 according to the third embodiment. The protruding parts 342 does not necessarily have the structure in which the protruding parts 342 protrude outward in the radial direction from the both sides of the magnetic flux capture member 340 in the circumferential direction C. As illustrated in FIG. 16B, for example, the magnetic flux capture member 340 may include a protruding part 342 protruding outward in the radial direction from one end in the circumferential direction C of the magnetic flux capture member 340. As illustrated in FIG. 16C, the magnetic flux capture member 340 may include only the curved part 341 of which thickness t in the circumferential direction C is uniform without the protruding part 342. Accordingly, it is possible to facilitate positioning the magnetic flux capture member 340 in fixing the magnetic flux capture member 340 to the insulator 350 with the necessary magnetic flux capture member 340 size to capture magnetic flux of the permanent magnet 12 (see, FIG. 1) kept to a minimum.

Further, as illustrated in FIG. 16D, the protruding part 342 may be provided in the center of the magnetic flux capture member 340 in the circumferential direction C. Accordingly, the interference between the protruding part 342 and the other magnetic flux capture member 340 adjoining in the circumferential direction C can be prevented.

### Advantage of Third Embodiment

According to the third embodiment described above, the magnetic flux capture member 340 includes the curved part 341 having the concave surface 341a facing inward in the radial direction. The shape of the curved part 341 as seen in the z-axis direction is, for example, a circular arc. Accordingly, in compared with a configuration in which a shape of a magnetic flux capture member as seen in the z-axis direction is a shape of a rectangle, a contact area where the magnetic flux capture member 340 is in contact with the stator core 20 increases and consequently the strength for fixing the magnetic flux capture member 340 can be improved. In addition, it is possible to facilitate positioning the magnetic flux capture member 340 in fixing the magnetic flux capture member 340 to the insulator 350.

In addition, according to the third embodiment, the protruding part 342 protrudes outward in the radial direction so that the magnetic flux capture member 340 widens in the circumferential direction C. Accordingly, even if magnetic suction is generated between the permanent magnet 12 and the magnetic flux capture member 340 during rotation, the magnetic flux capture member 340 does not easily come off.

In addition, according to the third embodiment, the width W₁ of the curved part 341 in the circumferential direction C is narrower than the width W₂ of the tooth end part 22b in the circumferential direction C. Accordingly, the interference between the two magnetic flux capture members 340 adjoining in the circumferential direction C can be prevented.

In addition, according to the third embodiment, the insulator 350 includes the first part 372a that is in contact with the center in the circumferential direction C of the magnetic flux capture member 340, and the second parts 372b that are provided on the ends (e.g., the protruding parts 342) in the circumferential direction C of the magnetic flux capture member 340 with first gaps G1 in between in the radial directions. Accordingly, the interference in positioning the magnetic flux capture member 340 in the axial direction between the insulator 350 and the protruding parts 342 can be prevented.

In addition, according to the third embodiment, the insulator 350 is provided across from the magnetic flux capture members 340 with the second gaps G₂ in between in the axial direction. Accordingly, the interference in positioning the magnetic flux capture members 340 in the axial direction between the insulator 350 and the magnetic flux capture members 340 can be prevented.

### First Variation of Third Embodiment

FIG. 17A is a plane view schematically illustrating a configuration of a magnetic flux capture member 340A according to a first variation of the third embodiment. In FIG. 17A, each component identical or corresponding to a component illustrated in FIG. 16A is assigned the same reference character as those in FIG. 16A. The electric motor according to the first variation of the third embodiment is different in shape of the magnetic flux capture member 340A from the electric motor according to the third embodiment. With respect to the other points, the electric motor according to the first variation of the third embodiment is the same as the electric motor according to the third embodiment. For that reason, FIG. 14 and others will now be referenced in the following explanations.

As illustrated in FIG. 17A, the magnetic flux capture member 340A includes the curved part 341 and protruding parts 342A. The protruding parts 342A are protruding parts of the magnetic flux capture member 340A in which the ends in the circumferential direction C of the curved part 341 are bent in the direction away from the permanent magnet 12 (see, FIG. 1). It should be noted that a first direction that is a direction in which each of the protruding parts 342A protrudes is not only the direction away from the permanent magnet 12 but also an approaching direction toward the permanent magnet 12 (see, e.g., FIG. 17B referenced later).

In the first variation of the third embodiment, the protruding parts 342A protrudes so that a width W₃ of the magnetic flux capture member 340A in the circumferential direction C is uniform in a direction away from the permanent magnet 12. In other words, side surfaces 345 of the magnetic flux capture member 340A extend parallel to the straight line S illustrated in FIG. 13A. Accordingly, when the magnetic flux capture members 340A are disposed on the teeth 22 (see, FIG. 14) respectively, the interference between the two magnetic flux capture members 340A adjoining in the circumferential direction C can be prevented. Therefore, in the first variation of the third embodiment, the width W₃ of the magnetic flux capture member 340A in the circumferential direction can be widen to the width W₂ of the tooth end part 22b of the tooth 22 in the circumferential direction C. Accordingly, the magnetic flux capture member 340A can capture easily the magnetic flux generated in the overhang part 12c of the permanent magnet 12.

FIG. 17B is a plane view schematically illustrating other example of the configuration of the magnetic flux capture member 340A according to the first variation of the third embodiment. As illustrated in FIG. 17B, the protruding parts 342A of the magnetic flux capture member 340A may protrude in an approaching direction toward the permanent magnet 12 (see, FIG. 1). In the example illustrated in FIG. 17B, when a fixing member (not shown) such as an insulator or a mold resin is in contact with the concave surface 341a of the curved part 341, this makes it possible to prevent the magnetic flux capture member 340A from coming off due to magnetic suction.

### Advantage of First Variation of Third Embodiment

According to the first variation of the third embodiment described above, the protruding parts 342A protrudes in the direction away from the permanent magnet 12 or the approaching direction toward the permanent magnet 12 so that the width W₃ of the magnetic flux capture member 340A in the circumferential direction C is uniform. This makes it possible to prevent the interference between the two magnetic flux capture members 340A adjoining in the circumferential direction C. Therefore, the width W₃ of the magnetic flux capture member 340A in the circumferential direction C can be widen to the width W₂ of the tooth end part 22b of the tooth 22 in the circumferential direction C. Accordingly, the magnetic flux capture member 340A can capture easily the magnetic flux generated in the overhang part 12c of the permanent magnet 12.

### Second Variation of Third Embodiment

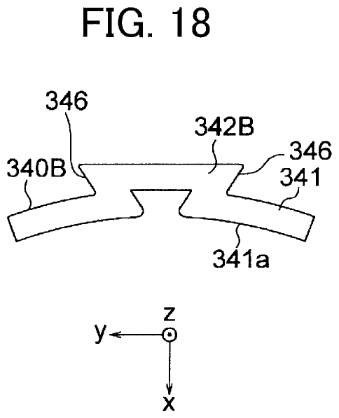

FIG. 18 is a plane view schematically illustrating a configuration of a magnetic flux capture member 340B according to a second variation of the third embodiment. In FIG. 18, each component identical or corresponding to a component illustrated in FIG. 16A is assigned the same reference character as those in FIG. 16A. The electric motor according to the second variation of the third embodiment is different in shape of the magnetic flux capture member 340B from the electric motor according to the third embodiment. With respect to the other points, the electric motor according to the second variation of the third embodiment is the same as the electric motor according to the third embodiment. For that reason, FIG. 14 will now be referenced in the following explanations.

As illustrated in FIG. 18, the magnetic flux capture member 340B includes the curved part 341 and a protruding part 342B. The protruding part 342B is provided in the center of the curved part 341 in the circumferential direction C. Accordingly, when the magnetic flux capture members 340B are disposed on the teeth 22 (see, FIG. 14) respectively, the interference between the two magnetic flux capture members 340B adjoining in the circumferential direction C can be prevented.

In addition, in the second variation of the third embodiment, the protruding part 342B widens as it is away from the curved part 341. Specifically, side surfaces 346 facing in the circumferential direction C of the protruding part 342B is inclined so that the protruding part 342B widens as it is away from the curved part 341. Accordingly, when a fixing member such as an insulator or a mold resin is in contact with the side surfaces 346, the strength for fixing the magnetic flux capture member 340B with respect to the fixing member is improved and consequently it is possible to prevent the magnetic flux capture member 340B from coming off due to magnetic suction.

### Advantage of Second Variation of Third Embodiment

According to the second variation of the third embodiment described above, the protruding part 342B of the magnetic flux capture member 340B widens as it is away from the curved part 341. Accordingly, when a fixing member such as an insulator or a mold resin is in contact with the side surfaces 346, the strength for fixing the magnetic flux capture member 340B with respect to the fixing member is improved and consequently it is possible to prevent the magnetic flux capture member 340B from coming off due to magnetic suction.

1. An electric motor comprising:
a rotor main body supported by a rotary shaft; and
a stator, wherein
the stator includes:
a stator core including a first end surface that is an end surface in an axial direction of the rotary shaft and a second end surface that is another end surface in the axial direction; and
a magnetic flux capture member disposed on a core end surface that is at least one of the first end surface or the second end surface, the magnetic flux capture member being made of magnetic material to capture magnetic flux from the rotor main body; and
a mold resin molded unitedly with the stator core, and
the magnetic flux capture member includes at least one of a bent part protruding in a direction away from the rotor main body or a curved part having a concave surface facing inward in a radial direction of the stator and fixed by the mold resin.

2. The electric motor according to claim 1, wherein a length of the stator core in the axial direction is shorter than a length of the rotor main body in the axial direction.

3. The electric motor according to claim 1, wherein the bent part is provided on at least one side of or both sides of the magnetic flux capture member in the axial direction.

4. The electric motor according to claim 1, wherein the bent part is inclined in the direction away from the rotor main body as the bent part is away from the core end surface.

5. The electric motor according to claim 1, wherein the mold resin is in contact with at least a part of an outer surface, in the radial direction, of the magnetic flux capture member.

6. The electric motor according to claim 5, wherein the mold resin includes an engagement part engaging with the bent part.

7. The electric motor according to claim 6, wherein the engagement part is a level difference part provided on a surface of the mold resin, the surface facing inward in the radial direction.

8. The electric motor according to claim 5, wherein the mold resin is in contact with an end part of the magnetic flux capture member in the axial direction, the end part being on an opposite side from the stator core.

9. The electric motor according to claim 5, wherein the mold resin is in contact with an inner surface, in the radial direction, of the bent part.

10. (canceled)

11. The electric motor according to claim 1, wherein a shape of the curved part as seen in the axial direction is a shape of a circular arc.

12. The electric motor according to claim 11, wherein
the stator core includes a yoke and a tooth,
the tooth includes:
a tooth main body extending inward in the radial direction from the yoke; and
a tooth end part disposed inward from the tooth main body in the radial direction and being wider than the tooth main body in a circumferential direction about the rotary shaft, and
a length of the curved part in the circumferential direction is shorter than a length of the tooth end part in the circumferential direction.

13. The electric motor according to claim 12, wherein the magnetic flux capture member further includes a protruding part as another bent part protruding from the curved part in a first direction that is a direction away from the rotor main body or an approaching direction toward the rotor main body.

14. The electric motor according to claim 13, wherein the protruding part is provided at least one of both sides of the curved part in the circumferential direction.

15. The electric motor according to claim 13, wherein the protruding part protrudes outward in the radial direction so that the magnetic flux capture member widens in the circumferential direction about the rotary shaft.

16. The electric motor according to claim 13, wherein the protruding part protrudes in the first direction so that a width of the magnetic flux capture member in the circumferential direction about the rotary shaft is uniform.

17. The electric motor according to claim 13, wherein the protruding part is provided at the center of the curved part in the circumferential direction.

18. The electric motor according to claim 17, wherein the protruding part widens as the protruding part is away from the curved part.

19. The electric motor according to claim 12, wherein
the stator further includes a fixing member that is in contact with the curved part and fixes the magnetic flux capture member, and
the fixing member includes:
a first part that is in contact with the center of the magnetic flux capture member in the circumferential direction; and
a second part provided across a first gap in the radial direction from an end of the magnetic flux capture member in the circumferential direction.

20. The electric motor according to claim 19, wherein the fixing member is provided across a second gap in the axial direction from the magnetic flux capture member.

21. The electric motor according to claim 2, wherein the bent part is provided on at least one side of or both sides of the magnetic flux capture member in the axial direction.
